(19) United States
(12) Patent Application Publication
(10) Pub. No.: US 2024/0203621 A1
(43) Pub. Date: Jun. 20, 2024

(54) COIL AND ENERGY CONVERSION DEVICE

(71) Applicant: AAC Microtech (Changzhou) Co., Ltd., Changzhou City (CN)

(72) Inventors: Yi Shao, Changzhou (CN); Xiujiang Si, Changzhou (CN)

(21) Appl. No.: 18/321,806

(22) Filed: May 23, 2023

Related U.S. Application Data
(63) Continuation of application No. PCT/CN2023/087087, filed on Apr. 7, 2023.

(30) Foreign Application Priority Data
Dec. 16, 2022 (CN) 202211625035.5

(51) Int. Cl. H01F 1/14; C22C 9/00; C22C 21/12; C22C 32/00

(52) U.S. Cl. CPC H01F 1/143; C22C 9/00; C22C 21/12; C22C 32/0084

(57) ABSTRACT

A coil and an energy conversion device are provided. The coil includes an enameled wire wound, and wherein the enameled wire includes a conductor portion, the conductor portion is made of materials including a base material and at least one of graphene and carbon nanotubes. A percentage of the base material in the materials is in a range of 70% to 99.8%, a percentage of the graphene in the materials is in a range of 0.2% to 30%, and a percentage of the carbon nanotubes in the materials is in a range of 0.2% to 30%. In this way, it is possible to simultaneously improve the conductivity and fatigue resistance characteristics of the enameled wire.

### CROSS REFERENCE TO RELATED APPLICATIONS

The present application is a continuation of PCT Patent Application No. PCT/CN2023/087087, filed Apr. 7, 2023, which claims priority to Chinese patent application No. 202211625035.5, filed Dec. 16, 2022, each of which is incorporated by reference herein in its entirety.

### TECHNICAL FIELD

The various embodiments described in this document relate in general to the technical field of coils, and more specifically to a coil and an energy conversion device.

### BACKGROUND

Coils generally refer to wires wound into loops. The coils have been widely used in motors, inductors, transformers, and loop antennas. The coil in a circuit refers to an inductor, which is a number of turns of wire wound around a core, and the number of turns of wire are insulated from each other. An insulated tube can be hollow or contain iron core or magnetic powder core, which is referred to as inductor for short.

After the coil is electrified, the coil may be moved under the action of electromagnetic force, thus generating mechanical energy. The higher the conductivity of the conductor of the coil, the higher the energy conversion efficiency and the higher the sensitivity. However, due to the vibration of the coil, it is easy to cause fatigue wire breakage of the coil.

### SUMMARY

Embodiments of the disclosure aim to provide a coil and an energy conversion device, so as to simultaneously improve the conductivity and tensile strength of a conductor portion of the coil.

In some embodiments, a coil is provided. The coil includes an enameled wire wound, and wherein the enameled wire includes a conductor portion, the conductor portion is made of materials including a base material and at least one of graphene and carbon nanotubes. A percentage of the base material in the materials is in a range of 70% to 99.8%, a percentage of the graphene in the materials is in a range of 0.2% to 30%, and a percentage of the carbon nanotubes in the materials is in a range of 0.2% to 30%.

In some embodiments, the percentage of the graphene in the materials is in a range of 0.2% to 1%.

In some embodiments, the percentage of the carbon nanotubes in the materials is in a range of 1% to 2%.

In some embodiments, the base material includes at least one of copper, aluminum, silver, gold, and copper alloys, and the at least one of the graphene and the carbon nanotubes are uniformly distributed in the base material.

In some embodiments, the base material includes a copper-clad aluminum conductor, and a percentage of copper of the copper-clad aluminum conductor in the conductor portion of the enameled wire is in a range of 10% to 80%, and a percentage of aluminum of the copper-clad aluminum conductor in the conductor portion of the enameled wire is in a range of 19.8% to 60%, and wherein the at least one of the graphene and the carbon nanotubes are uniformly distributed in the copper and/or aluminum of the copper-clad aluminum conductor.

In some embodiments, the copper of the copper-clad aluminum conductor is wrapped on a surface of the aluminum of the copper-clad aluminum conductor.

Embodiments of the disclosure further provide an energy conversion device. The energy conversion device includes a coil. The coil includes an enameled wire wound, and wherein the enameled wire includes a conductor portion, the conductor portion is made of materials including a base material and at least one of graphene and carbon nanotubes. A percentage of the base material in the materials is in a range of 70% to 99.8%, a percentage of the graphene in the materials is in a range of 0.2% to 30%, and a percentage of the carbon nanotubes in the materials is in a range of 0.2% to 30%.

In some embodiments, the energy conversion device is configured to convert electrical energy into mechanical energy, and the energy conversion device is one of a micro speaker, a vibration motor, and a transmission motor.

The coil of the technical solutions of the disclosure is applied to the speaker or the motor, the coil after being electrified generates electromagnetic force in a magnetic field to realize the conversion of electric energy to mechanical energy, the coil includes the enameled wire and the enameled wire includes the conductor portion. The conductor portion has higher electrical conductivity and mechanical performance by adopting the base material of the material proportion of 70% to 99.8%, and the graphene with a material proportion of 0.2% to 30% and/or the carbon nanotubes with a material proportion of 0.2% to 30%, such that the conductivity and tensile strength of the conductor portion of the enameled wire of the coil can be improved. The higher the electrical conductivity of the conductor portion of the coil, the higher the energy conversion efficiency of the speaker and the motor, and the higher sensitivity of the speaker and the higher the vibration amount of the motor, the stronger the anti-fatigue wire breakage ability of the conductor portion of the coil, and the coil is less prone to fatigue wire breakage due to vibration, thereby extending the service life of speaker. The coil provided in the disclosure applied to the speaker or the motor includes graphene and/or carbon nanotubes in a specific volume proportion, which can improve the conductivity by 19% international annealed copper standard (IACS), increase the sensitivity of the speaker by 1.51 dB, increase the tensile strength by 31 MPa, prolong the anti-fatigue wire breakage duration of the speaker by 45 hours at most, increase the steady-state response speed of the motor by 20%, and increase the transient vibration amount by 17%.

### BRIEF DESCRIPTION OF THE DRAWINGS

In order to more clearly explain that technical solutions in embodiments of the disclosure or existing technologies, the drawings required for use in the embodiments or the existing technologies will be briefly described below, and it will be apparent that the drawings described below are only some of the embodiments of the disclosure, from which other drawings may be obtained without creative effort by a person of ordinary skill in the art.

FIG. 1 is a structural schematic view of a speaker according to embodiments of the present disclosure.

FIG. 2 is a schematic cross-sectional view of the speaker of FIG. 1 in a A-A direction.

FIG. 3 is a schematic exploded view of the speaker of FIG. 1.

FIG. 4 is a structural view of a motor according to embodiments of the present disclosure.

FIG. 5 is a schematic cross-sectional view of the motor in FIG. 4 in a B-B direction.

FIG. 6 is a schematic exploded view of the motor in FIG. 4 without a housing.

The reference numerals are illustrated as follows:

| Reference numerals | Elements |
|---|---|
| 10 | speaker |
| 11 | case |
| 12 | coil |
| 20 | motor |
| 21 | housing |

The realization of the object, functional features, and advantages of the present disclosure will be further explained with reference to the accompanying drawings in connection with the embodiments.

### DETAILED DESCRIPTION OF THE EMBODIMENTS

A clear and complete description of the technical aspects of the embodiments of the disclosure will be given below in conjunction with the accompanying drawings in the embodiments of the disclosure, and it will be apparent that the described embodiments are only part of the embodiments of the disclosure, not all the embodiments of the disclosure. Based on the embodiments in the present disclosure, all other embodiments obtained without creative effort by those of ordinary skill in the art fall within the scope of protection of the present disclosure.

Embodiments of the disclosure provide a coil.

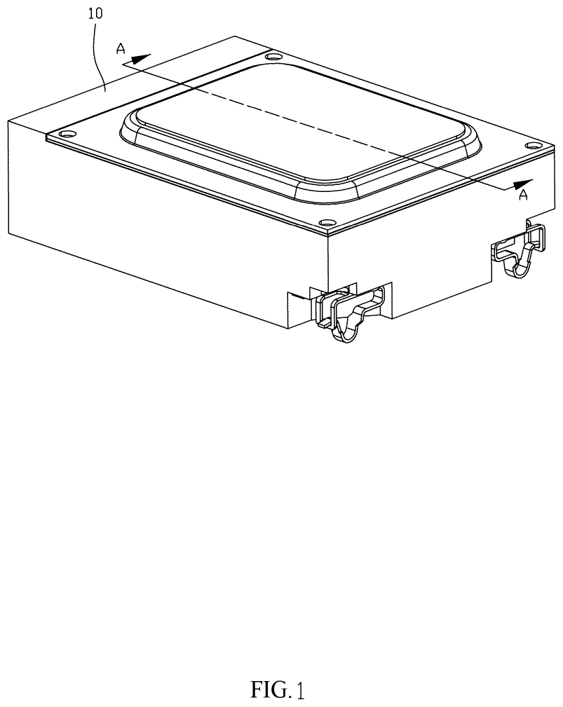

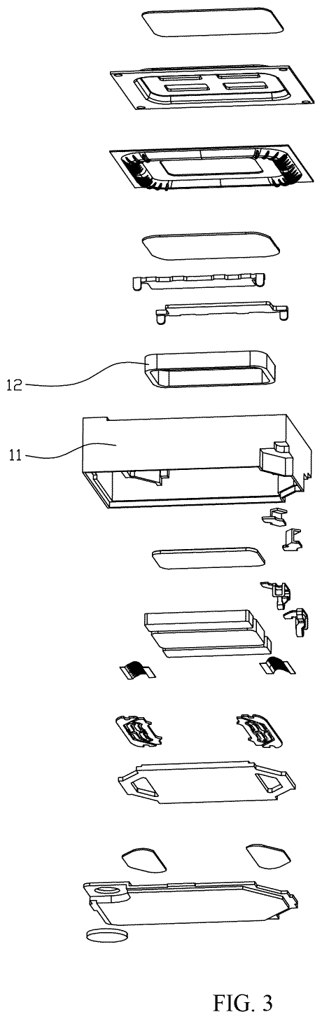

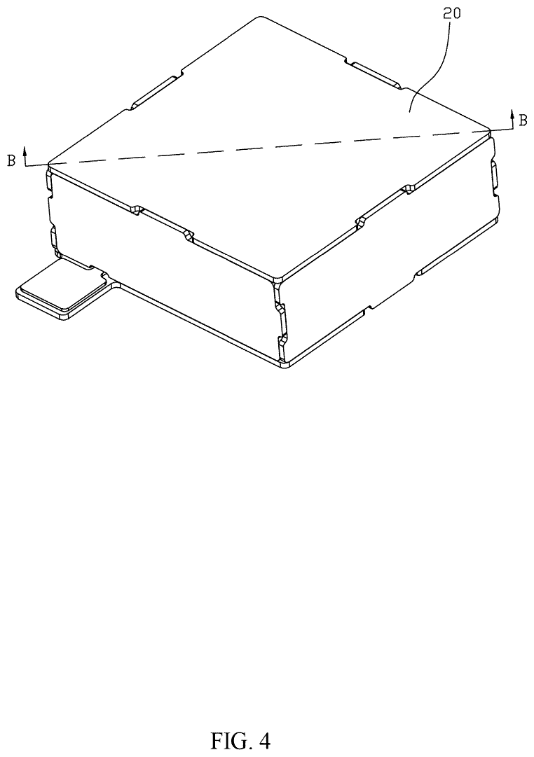

Referring to FIG. 1, FIG. 3, and FIG. 4, in embodiments of the present disclosure, a coil 12 is applicable to a speaker 10 or a motor 20. The coil 12 is formed by winding an enameled wire. The enameled wire includes a conductor portion. The conductor portion is made of materials including a base material and graphene and/or carbon nanotubes, where a percentage of the base material in the materials is in a range of 70% to 99.8%, a percentage of the graphene in the materials is in a range of 0.2% to 30%, and a percentage of the carbon nanotubes in the materials is in a range of 0.2% to 30%.

In the technical solutions of the disclosure, the coil 12 is applied to the speaker 10 or the motor 20, the electrified coil 12 generates electromagnetic force in the magnetic field to realize conversion of electric energy to mechanical energy. Since the conductor portion of the enameled wire of the coil 12 is made from the base material with a material proportion of 70% to 99.8% (i.e., the percentage of the base material in the materials for preparing the conductor portion is in the range of the 70% to 99.8%) and the graphene with a material proportion of 0.2% to 30% and/or the carbon nanotubes with a material proportion of 0.2% to 30%, the coil 12 has relatively high electrical conductivity and mechanical properties, such that the conductivity and tensile strength of the conductor portion of the enameled wire of the coil 12 can be improved. The higher the electrical conductivity of the conductor portion of the coil 12, the higher the energy conversion efficiency of the speaker 10 and the motor 20, and the higher sensitivity of the speaker 10 and the higher the vibration amount of the motor 20, the stronger the anti-fatigue wire breakage ability of the conductor portion of the coil 12, and the coil 12 is less prone to fatigue wire breakage due to vibration, thereby extending the service life of speaker 10. The coil 12 provided in the disclosure applied to the speaker 10 or the motor 20 includes graphene and/or carbon nanotubes in a specific volume proportion, which can improve the conductivity by 19% international annealed copper standard (IACS), increase the sensitivity of the speaker 10 by 1.51 dB, increase the tensile strength by 31 MPa, prolong the anti-fatigue wire breakage duration of the speaker 10 by 45 hours at most, increase the steady-state response speed of the motor 20 by 20%, and increase the transient vibration amount by 17%.

Specifically, the base material is made of a conductive material which may generate an electromagnetic force in a magnetic field after being electrified, so that mechanical motion can be generated. The base material can be metal material, alloy material, or polymer material with conductive function, as long as the material of the base material can generate electromagnetic force after being electrified.

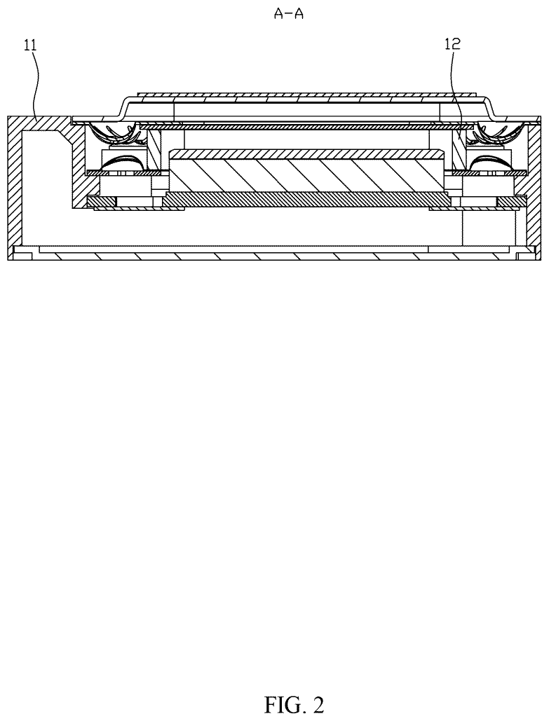

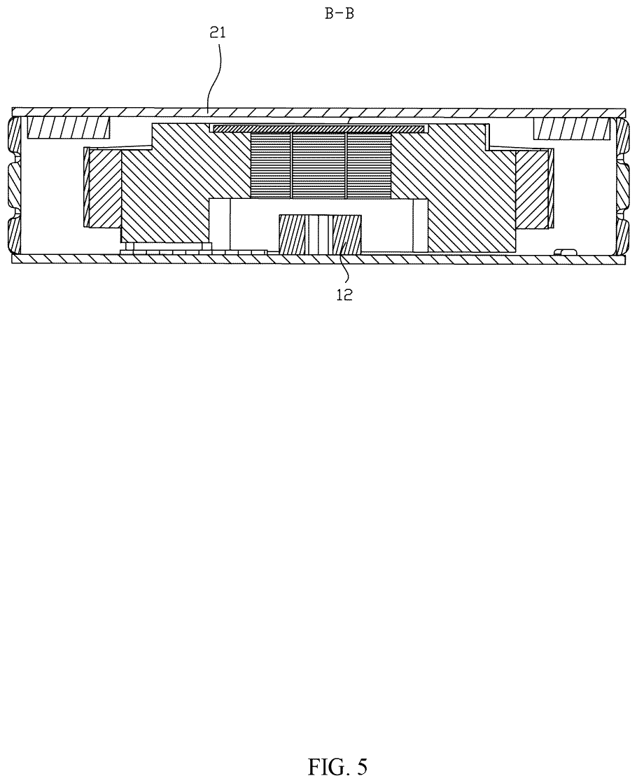

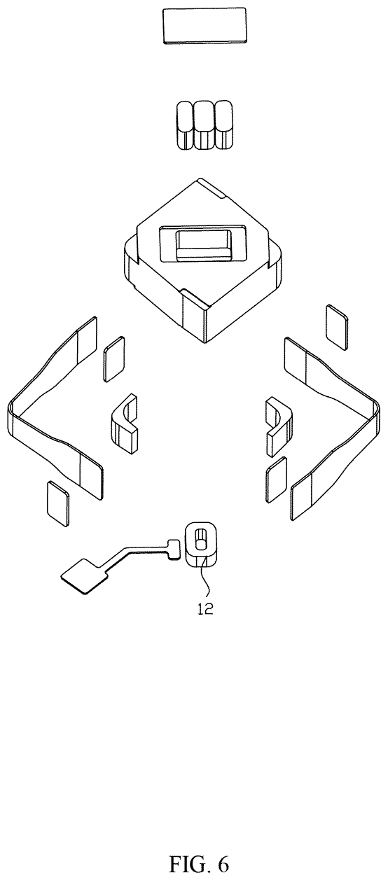

Referring to FIGS. 1 to 3, the speaker 10 may include a case 11 and a coil 12, and the coil 12 may be mounted within the case 11. It shall be understood that the coil 12 may be a voice coil and the case 11 may include a bottom plate, a side plate, and a top plate. Referring to FIGS. 4 to 6, the motor 20 may include a housing 21 and a vibration assembly, the vibration assembly may include the coil 12, and the motor 20 can achieve conversion of electrical energy to mechanical energy through the coil 12.

In one embodiment, the base material includes one or more of copper, aluminum, silver, gold, or copper alloys. That is, the base material can be a single material, such as pure copper. Alternatively, the base material can be a variety of materials, such as copper-clad aluminum, alloy materials and so on. By using the base material with conductive function as the main material of the coil 12, the coil 12 can generate electromagnetic force after being electrified, and then generate mechanical motion, and then drive components to move.

In one embodiment, the base material is a copper-clad aluminum conductor, which reduces the amount of copper used, thereby reducing the production cost. By adding aluminum in the copper, the coil 12 may have strong plasticity. In addition, since the density of copper-clad aluminum is 1/2.5 of that of pure copper, the weight of the coil 12 is reduced. Moreover, the length of the coil 12 including the copper-clad aluminum is much longer than the length of the coil 12 including the pure copper on condition that the base material including the copper-clad aluminum and the base material including the pure copper have a same diameter and weight, thereby further greatly reducing the production cost of the coil 12. In one embodiment, a volume fraction (percentage) of copper of the copper-clad aluminum conductor in the conductor portion of the enameled wire is in a range of 10% to 80%, and a volume fraction (percentage) of aluminum of the copper-clad aluminum conductor in the conductor portion of the enameled wire is in a range of 19.8% to 60%.

In one embodiment, in the copper-clad aluminum conductor, copper wraps a surface of the aluminum, thereby forming the copper-clad aluminum conductor. In one embodiment, in the conductor portion of the enameled wire including the graphene and/or the carbon nanotubes and the base material, the graphene and/or the carbon nanotube may be uniformly distributed in the base material, so that the graphene and/or the carbon nanotube are uniformly distributed, which is more conducive to improving the conductivity and tensile strength of the enameled wire.

Specifically, the materials for preparing the coil 12 includes the graphene. The graphene can be a nano material or a non-nano material. The graphene has extremely high conductivity, the conductivity of the graphene is at least 100 times higher than that of copper, and can make electrons move at least 100 times faster than that of monocrystalline silicon, thereby improving the overall conductivity of the coil 12, further improving the energy conversion efficiency and sensitivity of the coil 12, reducing energy loss, and shortening reaction time. Moreover, the graphene has extremely high strength, the strength of the graphene is at least 200 times greater than that of steel. Furthermore, the graphene has high thermal conductivity and high tensile strength, and even if the graphene is stretched or bent, electrical properties of the graphene are also maintained. Therefore, adding graphene to the coil 12 can not only improve the conductivity of the coil 12, but also increase the tensile strength of the coil 12, and improve the energy conversion efficiency, sensitivity, and fatigue wire breakage resistance of the coil 12.

The content of the graphene should not be too high or too low (i.e., the percentage of the graphene in the materials for preparing the coil 12 should not be too high or too low). On one hand, if the content of the graphene is too high, it will not only greatly increase the material cost, waste materials, but also easily reunite, which is not conducive to the dispersion of graphene in the substrate. On the other hand, if the content of the graphene is too low, the electrical conductivity and tensile strength of the coil 12 may not be improved, and the coil 12 having high electrical conductivity and tensile strength may not be obtained. Therefore, the graphene accounts for 0.2% to 30% of the materials for preparing the coil 12. For example, in one embodiment, the graphene accounts for 0.2% to 1% of the materials.

Specifically, the carbon nanotube is a one-dimensional quantum material with special structure (radial size is nanometer, axial size is micron, and both ends of the tube are basically sealed). The carbon nanotube includes several to dozens of coaxial circular tubes mainly composed of carbon atoms arranged in hexagons, with a fixed distance between layers. For example, the layers can be separated from each other by about 0.34 nm and a diameter of each coaxial circular tube is in a range of 2 nm to 20 nm. According to the different orientations of the carbon hexagon along the axial direction, the carbon nanotube may have a zigzag (serrated) shape, an armchair shape, or a spiral shape.

The carbon nanotubes are one-dimensional nanomaterials, which are light in weight, perfectly connected in hexagonal structure and have many abnormal mechanical and chemical properties. The coil 12 may have good strength, elasticity, fatigue resistance, and the like by adding carbon nanotubes into the base material, thus greatly improving various properties of the coil 12. Because the structure of the carbon nanotubes is the same as the lamellar structure of graphite, they have good electrical properties, and the conductivity of the carbon nanotubes can reach 10,000 times that of copper. In addition, the carbon nanotubes have great tensile strength, and the strength of the carbon nanotubes is 100 times that of steel, but the density of the carbon nanotubes is only one sixth of that of steel, which is one order of magnitude higher than that of conventional graphite fibers. The elastic modulus of the carbon nanotubes can reach 1 TPa, which is equivalent to the elastic modulus of diamond and about 5 times the elastic modulus of steel. Although the structure of the carbon nanotubes is similar to that of polymer materials, the carbon nanotubes is much more stable than polymer materials in structure.

Similarly, the content of the carbon nanotubes should not be too high or too low (i.e., the percentage of the carbon nanotubes in the materials for preparing the coil 12 should not be too high or too low). If the content of the carbon nanotubes is too high, it will not only increase the material cost and waste materials, but also easily reduce the conductivity and tensile strength of the coil 12. If the content of the carbon nanotubes is too low, the electrical conductivity and tensile strength of the coil 12 may not be improved, and the coil 12 with high electrical conductivity and tensile strength may not be obtained. Therefore, the carbon nanotubes accounts for 0.2% to 30% of the materials for preparing the coil 12. For example, in one embodiment, the carbon nanotubes accounts for 1% to 2% of the materials for preparing the coil 12.

In one embodiment, the coil 12 is formed by winding the enameled wire. The enameled wire includes a conductor portion and an insulator portion. The enameled wire is formed after the bare wire is annealed and softened, and then subjected to painting multiple times and heated. The enameled wire may include copper enameled wire, aluminum enameled wire, or copper-aluminum alloy enameled wire, or the like. The coil 12 may be formed by winding the enameled wire in a certain shape, and may consist of one or more turns of enameled wires that are connected in series. The coil 12 may have two lead-out wires, one lead-out wire is called a head end, and the other lead-out wire is called a tail end. The enameled wire is simple in process, low in price and thick, thus further reducing the production cost of the coil 12. Since the coil 12 is formed by winding the enameled wires, the interference magnetic field is well suppressed, and the accuracy can be improved.

Embodiments of the disclosure further provide an energy conversion device. The energy conversion device includes a coil 12. For the specific structure of the coil 12, reference may be made to the above-mentioned embodiments. Since the energy conversion device adopts all the technical schemes of the above-mentioned embodiments, the energy conversion device has at least all the beneficial effects brought by the technical schemes of the above-mentioned embodiments, which are not repeated herein. The energy conversion device is configured to convert electrical energy into mechanical energy, and the energy conversion device can be the speaker 10 or the motor 20.

In one embodiment, the speaker 10 is a micro speaker, or the motor 20 is a vibration motor or a transmission motor. The micro speaker may include a basin frame, a magnetic steel, a pole piece, a sound film, and a voice coil, where the voice coil includes the coil 12 described above. By adopting the coil 12 in the micro speaker 10, the conductivity and tensile strength of the coil 12 in the micro speaker 10 are improved, so that the service life of the speaker 10 with a small volume can be prolonged. Both the vibration motor and the transmission motor include the coil 12, and a direction of an input current of the vibration motor is different due to the coil 12, so that the drive assembly rotates. When the drive assembly rotates, a center particle of the eccentric wheel is not on a rotating center of the motor, and the drive assembly is continuously in an out-of-balance state, thus resulting in vibration due to inertia. By adopting the coil 12 in the micro speaker, the vibration motor, and the transmission motor, electrical energy can be converted into mechanical energy, such that the drive assembly is rotated, thereby achieving corresponding effects.

Embodiments of the disclosure will be described in detail below in connection with specific embodiments, but those skilled in the art shall understand that the following embodiments are intended to illustrate the disclosure only and should not be taken as limiting the scope of the disclosure. If specific conditions are not specified in the embodiment, the conventional conditions or the conditions recommended by the manufacturer shall be followed. If the manufacturer is not indicated, the reagents or instruments used are conventional products that can be purchased through the market.

### Embodiment 1

A coil is provided. The coil is made of materials including pure copper and graphene, where a percentage of the pure copper in the materials is 99.5% and a percentage of the graphene in the materials is 0.5%, and the graphene is uniformly distributed in the base material of the pure copper. A voice coil is formed by winding an enameled wire (a diameter of a conductor portion of the enameled wire is 0.03 mm), and the voice coil is assembled into a micro speaker of 0815-size in a watch.

### Embodiment 2

A coil is provided. The coil is made of materials including copper-clad aluminum conductor and graphene, where a percentage of the copper-clad aluminum conductor in the materials is 99.8% (containing 15% of copper) and a percentage of the graphene in the materials is 0.2%, and the graphene is uniformly distributed in the copper-clad aluminum conductor. A voice coil is formed by winding an enameled wire (a diameter of a conductor portion of the enameled wire is 0.03 mm), and the voice coil is assembled into a micro speaker of 1520-size in a PAD.

### Embodiment 3

A coil is provided. The coil is made of materials including pure copper and graphene, where a percentage of the pure copper in the materials is 70% and a percentage of the graphene in the materials is 30%, and the graphene is uniformly distributed in the base material of the pure copper. A voice coil is formed by winding an enameled wire (a diameter of a conductor portion of the enameled wire is 0.03 mm), and the voice coil is assembled into a micro speaker of 1134-size in a PAD.

### Embodiment 4

A coil is provided. The coil is made of materials including copper-clad aluminum conductor and carbon nanotubes, where a percentage of the copper-clad aluminum conductor in the materials is 85% (containing 30% of copper) and a percentage of the carbon nanotubes in the materials is 15%, and the carbon nanotubes are uniformly distributed in the copper-clad aluminum conductor. A voice coil is formed by winding an enameled wire (a diameter of a conductor portion of the enameled wire is 0.03 mm), and the voice coil is assembled into a micro speaker of 1520-size in a PAD.

### Embodiment 5

A coil is provided. The coil is made of materials including pure copper, graphene, and carbon nanotubes, where a percentage of the pure copper in the materials is 98%, a percentage of the graphene in the materials is 1%, and a percentage of the carbon nanotubes is 1%, and the graphene and the carbon nanotubes are uniformly distributed in the base material of the pure copper. A voice coil is formed by winding an enameled wire (a diameter of a conductor portion of the enameled wire is 0.03 mm) to prepare a receiver of 0809-size.

### Embodiment 6

A coil is provided. The coil is made of materials including pure copper and carbon nanotubes, where a percentage of the pure copper in the materials is 98% and a percentage of the carbon nanotubes in the materials is 2%, and the carbon nanotubes are uniformly distributed in the base material of the pure copper. A voice coil is formed by winding an enameled wire (a diameter of a conductor portion of the enameled wire is 0.03 mm), and the voice coil is assembled into a vibration motor of 0815-size in a mobile phone.

### Embodiment 7

A coil is provided. The coil is made of materials including pure copper and graphene, where a percentage of the pure copper in the materials is 75% and a percentage of the graphene in the materials is 25%, and the graphene is uniformly distributed in the base material of the pure copper. A voice coil is formed by winding an enameled wire (a diameter of a conductor portion of the enameled wire is 0.03 mm), and the voice coil is assembled into a vibration motor of 0620-size in a mobile phone.

### Comparative Example 1

A coil is made of materials including pure copper, where a percentage of the pure copper in the materials is 100%. A voice coil is formed by winding an enameled wire (a diameter of a conductor portion of the enameled wire is 0.03 mm), and the voice coil is assembled into a micro speaker of 0815-size in a watch.

### Comparative Example 2

A coil is made of materials including copper-clad aluminum conductor, where a percentage of the copper-clad aluminum conductor in the materials is 100% (containing 15% of copper). A voice coil is formed by winding an enameled wire (a diameter of a conductor portion of the enameled wire is 0.03 mm), and the voice coil is assembled into a micro speaker of 1520-size in a PAD.

### Comparative Example 3

A coil is made of materials including pure copper, where a percentage of the pure copper in the materials is 100%. A voice coil is formed by winding an enameled wire (a diameter of a conductor portion of the enameled wire is 0.03 mm), and the voice coil is assembled into a micro-speaker of 1134-size in a PAD.

### Comparative Example 4

A coil is made of materials including copper-clad aluminum conductor, where a percentage of the copper-clad aluminum conductor in the materials is 100% (containing 30% of copper). A voice coil is formed by winding an enameled wire (a diameter of a conductor portion of the enameled wire is 0.03 mm), and the voice coil is assembled into a micro speaker of 1520-size in a PAD.

### Comparative Example 5

A coil is made of materials including pure copper, where a percentage of the pure copper in the materials is 100%. A voice coil is formed by winding an enameled wire (a diameter of a conductor portion of the enameled wire is 0.03 mm), to prepare a receiver of 0809-size.

### Comparative Example 6

A coil is made of materials including pure copper, where a percentage of the pure copper in the materials is 100%. A voice coil is formed by winding an enameled wire (a diameter of a conductor portion of the enameled wire is 0.03 mm), and the voice coil is assembled into a vibration motor of 0815-size in a mobile phone.

### Comparative Example 7

A coil is made of materials including pure copper, where a percentage of the pure copper in the materials is 100%. A voice coil is formed by winding an enameled wire (a diameter of a conductor portion of the enameled wire is 0.03 mm), and the voice coil is assembled into a vibration motor of 0620-size in a mobile phone.

For the components and corresponding contents of the components of Embodiments 1 to 7 and Comparative Examples 1 to 7 above, reference may be made to Tables 1 to 2 below.

TABLE 1
Table of components and percentage of components of speaker and receiver

| | | | Carbon | | |
|---|---|---|---|---|---|
| | | Graphene/ | nanotubes/ | | |
| | Base material/ | percentage | percentage | | Electronic |
| Samples | percentage (%) | (%) | (%) | Size | device |
| Embodiment 1 | Pure copper 99.5 | 0.5 | / | 0815 | Micro speaker |
| Embodiment 2 | Copper-clad | 0.2 | / | 1520 | Micro speaker |
| | aluminum conductor | | | | |
| | (containing 15% | | | | |
| | of copper) 99.8 | | | | |
| Embodiment 3 | Pure copper 70.0 | 30 | / | 1134 | speaker |
| Embodiment 4 | Copper-clad | / | 15 | 1520 | Micro speaker |
| | aluminum conductor | | | | |
| | (containing 30% | | | | |
| | of copper) 85.0 | | | | |
| Embodiment 5 | Pure copper 98.0 | 1 | 1 | 0809 | Receiver |
| Comparative | Pure copper 100.0 | / | / | 0815 | Micro speaker |
| Example 1 | | | | | |
| Comparative | Copper-clad | / | / | 1520 | Micro speaker |
| Example 2 | aluminum conductor | | | | |
| | (containing 15% | | | | |
| | of copper) 100.0 | | | | |
| Comparative | Pure copper 100.0 | / | / | 1134 | speaker |
| Example 3 | | | | | |
| Comparative | Copper-clad | / | / | 1520 | Micro speaker |
| Example 4 | aluminum conductor | | | | |
| | (containing 30% | | | | |
| | of copper)100.0 | | | | |
| Comparative | Pure copper 100 | / | / | 0809 | Receiver |
| Example 5 | | | | | |

TABLE 2
Table of components and percentage of the components of motor

| | Base | | Carbon | | |
|---|---|---|---|---|---|
| | material/ | Graphene/ | nanotubes/ | | |
| | percentage | percentage | percentage | | Electronic |
| Samples | (%) | (%) | (%) | Size | device |
| Embodiment 6 | Pure copper | / | 2 | 0815 | Vibration |
| | 98 | | | | motor |
| Embodiment 7 | Pure copper | 25 | / | 0620 | Vibration |
| | 75 | | | | motor |
| Comparative | Pure copper | / | / | 0815 | Vibration |
| Example 6 | 100 | | | | motor |
| Comparative | Pure copper | / | / | 0620 | Vibration |
| Example 7 | 100 | | | | motor |

In order to verify the various properties of the coils of the present invention, the product properties of the above seven embodiments and seven comparative examples were tested. The results refer to tables 3-4 below.

TABLE 3
Performance test results of speaker and receiver

| | | Sensi- | Tensile | Anti-fatigue |
|---|---|---|---|---|
| | Conductivity/ | tivity/ | strength/ | wire breakage |
| Samples | % IACS | dB | MPa | duration/hour |
| Comparative | 100 | 102.00 | 267 | 152 |
| Example 1 | | | | |
| Embodiment 1 | 112 | 102.98 | 295 | 174 |
| Comparative | 63 | 125.10 | 217 | 134 |
| Example 2 | | | | |
| Embodiment 2 | 67 | 125.63 | 259 | 157 |
| Comparative | 100 | 102.30 | 264 | 234 |
| Example 3 | | | | |
| Embodiment 3 | 135 | 104.90 | 380 | 942 |
| Comparative | 63 | 125.10 | 217 | 134 |
| Example 4 | | | | |
| Embodiment 4 | 83 | 127.50 | 318 | 526 |
| Comparative | 100 | 122.10 | 279 | 168 |
| Example 5 | | | | |
| Embodiment 5 | 111 | 123.00 | 310 | 213 |

According to Tables 1 and 2, in Embodiments 1 to 7, the coil includes the graphene and/or the carbon nanotubes, a sum of a percentage of the substrate and the graphene and/or carbon nanotubes is 100%, and all the coils are formed by winding enameled wires, a diameter of the conductor portion of each enameled wire is 0.03 mm, and the assembled electronic device is a micro speaker, a vibration motor, and a receiver. In contrast, in Comparative Examples 1 to 7, the coil does not contain graphene or carbon nanotubes, and the materials for preparing the coil are all base material, i.e., the percentage of the base material in the materials for preparing the conductor portion is 100%. The other conditions are the same as those in corresponding Embodiments. That is, all the coils are formed by winding enameled wires, a diameter of the conductor portion of each enameled wire is 0.03 mm, and the assembled electronic device is a micro speaker, a vibration motor, and a receiver.

According to Tables 1 and 3, the conductor portion of the enameled wire is used in the speakers and receivers. Compared with Comparative Example 1, the coil of Embodiment 1 includes graphene of a material proportion of 0.5%, the conductivity of the coil is improved by 12% IACS, the sensitivity of the coil is improved by 0.98 dB, and the tensile strength of the coil is increased from 267 MPa to 295 MPa. In addition, the anti-fatigue wire breakage duration is prolonged from 152 hours to 174 hours after a 1 W sinusoidal signal is inputted. Similarly, compared to Comparative Example 3, the coil of Embodiment 3 includes graphene of a material proportion of 30%, and the conductivity of the coil is improved by 35% IACS, the sensitivity of the coil is improved by 2.70 dB, the tensile strength of the coil is increased by 116 MPa, and anti-fatigue wire breakage duration is prolonged by 708 hours. The volume fraction (material proportion) of graphene in Embodiment 3 is increased, and the conductivity, tensile strength, and anti-fatigue wire breakage duration of the coil are greatly improved compared with Embodiment 1.

The base materials of Embodiment 2 and Comparative Example 2 were both copper-clad aluminum conductors (containing 15% of copper). In Embodiment 2, the coil includes graphene of a material proportion of 0.2% and copper-clad aluminum conductor of a material proportion of 99.8%, while the coil in Comparative Example 2 only includes a copper-clad aluminum conductor of a material proportion of 100%. The coil in Embodiment and the coil in Comparative Example 2 are assembled into a micro speaker of 1520-size in a PAD. As can be seen from Table 3, compared with Comparative Example 2, in Embodiment 2 of the disclosure, the conductivity of the coil is increased from 63% IACS to 67% IACS, the sensitivity of the coil is increased from 125.10 dB to 125.63 dB, the tensile strength of the coil is increased from 217 MPa to 259 MPa, and the anti-fatigue wire breakage duration of the coil is prolonged from 134 hours to 157 hours.

Similarly, compared with Comparative Example 4, the coil in Embodiment 4 includes carbon nanotubes of a material proportion of 15%, the rest materials being copper-clad aluminum conductors (containing copper of 30%), with an increase in conductivity of 20% IACS, an increase in sensitivity of 2.40 dB, an increase in tensile strength of 101 MPa, and an increase in anti-fatigue wire breakage duration of almost 400 hours. In Embodiment 4, carbon nanotubes accounts for 15% of the materials, the volume fraction of the carbon nanotubes is much larger than the volume fraction (0.2%) of graphene in Embodiment 2, and the conductivity, tensile strength, and anti-fatigue wire breakage duration of the coil are greatly improved.

The base material of Embodiment 5 is pure copper, the graphene of a material proportion of 1% and the carbon nanotube of a material proportion of 1% are added, where the sum of the volume fraction (material proportion) of the base material, the graphene, and the carbon nanotube is 100%. The coil of Comparative Example 5 only includes pure copper of the material proportion of 100%. According to the performance test results, compared with Comparative Example 5, the conductivity of the coil of Embodiment 5 is improved by 11% IACS, the sensitivity of the coil is improved by 0.90 dB, the tensile strength of the coil is increased from 279 MPa to 310 MPa, and the tensile strength of the coil is increased by 31 MPa. Furthermore, in the maximum power experiment, the duration of anti-fatigue wire breakage duration was increased by 45 hours from 168 hours in Comparative Example 5 to 213 hours in Embodiment 5. Therefore, adding graphene and carbon nanotube in the materials for preparing the coils improves the conductivity, sensitivity, and tensile strength of the conductors of the enameled wire, and greatly enhances the fatigue resistance.

TABLE 4
Performance test results of motor products

| | | | Transient |
|---|---|---|---|
| | Conductivity/ | Steady-state response | vibration |
| Samples | % IACS | speed (RT/BT)/ms | amount (Gp) |
| Comparative | 100 | 48.2 | 1.741 |
| Example 6 | | | |
| Embodiment 6 | 119 | 39.3 | 2.063 |
| Comparative | 100 | 45.0 | 1.828 |
| Example 7 | | | |
| Embodiment 7 | 130 | 33.1 | 2.376 |

As can be seen from Tables 2 and 4, compared with Comparative Example 6, the conductor portion of the enameled wire of Embodiment 6 includes carbon nanotube of material proportion of 2%, and the conductivity of Embodiment 6 is improved by 19% IACS, steady-state response speed of Embodiment 6 is improved by 8.9 ms, i.e., the steady-state response speed of the motor is improved by 18.5%, and the transient vibration amount is improved by 0.322. Similarly, compared with Comparative Example 7, the conductor portion of the enameled wire of Embodiment 7 includes graphene of a material proportion of 25% and pure copper of a material proportion of 75%, and the conductivity is fully improved by 30% IACS, the steady-state response speed of the motor is improved by 26.4%, and the transient vibration amount is improved by 30.0%.

Therefore, the conductivity of the conductor of the enameled wire of the coil of the disclosure containing graphene and carbon nanotubes is improved, the sensitivity (of the speaker) or vibration amount (of the motor) is also improved, and the steady-state response speed (of the motor) is shortened. Moreover, the tensile strength of the speaker or the transient vibration amount of the motor are greatly improved.

The above is only an optional embodiment of the present disclosure, and is not therefore limiting the patent scope of the present disclosure. Any equivalent structural transformation made by using the contents of the present specification and drawings, or direct/indirect disclosure in other related technical fields, under the inventive concept of the present disclosure, is included in the patent protection scope of the present disclosure.

What is claimed is:

1. A coil, being applicable to a speaker or a motor, wherein the coil includes an enameled wire wound, and wherein the enameled wire includes a conductor portion, the conductor portion is made of materials including a base material and at least one of graphene and carbon nanotubes, wherein
a percentage of the base material in the materials is in a range of 70% to 99.8%, a percentage of the graphene in the materials is in a range of 0.2% to 30%, and a percentage of the carbon nanotubes in the materials is in a range of 0.2% to 30%.

2. The coil of claim 1, wherein the percentage of the graphene in the materials is in a range of 0.2% to 1%.

3. The coil of claim 1, wherein the percentage of the carbon nanotubes in the materials is in a range of 1% to 2%.

4. The coil of claim 1, wherein the base material includes at least one of copper, aluminum, silver, gold, and copper alloys, and the at least one of the graphene and the carbon nanotubes are uniformly distributed in the base material.

5. The coil of claim 4, wherein the base material includes a copper-clad aluminum conductor, and a percentage of copper of the copper-clad aluminum conductor in the conductor portion of the enameled wire is in a range of 10% to 80%, and a percentage of aluminum of the copper-clad aluminum conductor in the conductor portion of the enameled wire is in a range of 19.8% to 60%, and wherein the at least one of the graphene and the carbon nanotubes are uniformly distributed in the copper and/or aluminum of the copper-clad aluminum conductor.

6. The coil of claim 5, wherein the copper of the copper-clad aluminum conductor is wrapped on a surface of the aluminum of the copper-clad aluminum conductor.

7. The coil of claim 2, wherein the base material includes at least one of copper, aluminum, silver, gold, and copper alloys, and the at least one of the graphene and the carbon nanotubes are uniformly distributed in the base material.

8. The coil of claim 3, wherein the base material includes at least one of copper, aluminum, silver, gold, and copper alloys, and the at least one of the graphene and the carbon nanotubes are uniformly distributed in the base material.

9. An energy conversion device, comprising a coil, wherein the coil includes an enameled wire wound, and wherein the enameled wire includes a conductor portion, the conductor portion is made of materials including a base material and at least one of graphene and carbon nanotubes, wherein
a percentage of the base material in the materials is in a range of 70% to 99.8%, a percentage of the graphene in the materials is in a range of 0.2% to 30%, and a percentage of the carbon nanotubes in the materials is in a range of 0.2% to 30%.

10. The energy conversion device of claim 9, wherein the energy conversion device is configured to convert electrical energy into mechanical energy, and the energy conversion device is one of a micro speaker, a vibration motor, and a transmission motor.

11. The energy conversion device of claim 9, wherein the percentage of the graphene in the materials is in a range of 0.2% to 1%.

12. The energy conversion device of claim 9, wherein the percentage of the carbon nanotubes in the materials is in a range of 1% to 2%.

13. The energy conversion device of claim 9, wherein the base material includes at least one of copper, aluminum, silver, gold, and copper alloys, and the at least one of the graphene and the carbon nanotubes are uniformly distributed in the base material.

14. The energy conversion device of claim 13, wherein the base material includes a copper-clad aluminum conductor, and a percentage of copper of the copper-clad aluminum conductor in the conductor portion of the enameled wire is in a range of 10% to 80%, and a percentage of aluminum of the copper-clad aluminum conductor in the conductor portion of the enameled wire is in a range of 19.8% to 60%, and wherein the at least one of the graphene and the carbon nanotubes are uniformly distributed in the copper and/or aluminum of the copper-clad aluminum conductor.

15. The energy conversion device of claim 14, wherein the copper of the copper-clad aluminum conductor is wrapped on a surface of the aluminum of the copper-clad aluminum conductor.

16. The energy conversion device of claim 11, wherein the base material includes at least one of copper, aluminum, silver, gold, and copper alloys, and the at least one of the graphene and the carbon nanotubes are uniformly distributed in the base material.

17. The energy conversion device of claim 12, wherein the base material includes at least one of copper, aluminum, silver, gold, and copper alloys, and the at least one of the graphene and the carbon nanotubes are uniformly distributed in the base material.
